(19) United States
(12) Patent Application Publication
(10) Pub. No.: US 2007/0163518 A1
(43) Pub. Date: Jul. 19, 2007

(54) Horse lead system and related method

(76) Inventor: Donald Motsenbocker, McKinney, TX (US)

Correspondence Address: CASH KLEMCHUK POWERS TAYLOR LLP, CAMPBELL CENTRE II, 8150 NORTH CENTRAL EXPRESSWAY, SUITE 1575, DALLAS, TX, 75206, US

(21) Appl. No.: 11/334,861

(22) Filed: Jan. 19, 2006

(51) Int. Cl. A01K 27/00

(52) U.S. Cl. 119/795

(57) ABSTRACT

A horse lead is provided. The horse lead includes a length of lead material comprising a first end and a second end. The first end comprises a permanently braided or twisted segment forming a first loop. A connector is coupled to the first loop and a second loop is formed, interconnected with the first loop. A snap is provided, comprising a clasp and a third loop, and the third loop is coupled to the second loop.

### BACKGROUND

1. Field of the Invention

The present invention relates generally to the field of equine training and control equipment and mechanisms and in particular to an improved horse lead system and related method.

2. Description of Related Art

Modern equine training requires a certain degree of control over both the horse and the human involved in the training. Human control is typically self-control, provided by the trainer himself and developed over time. The trainer's self-control depends on many factors, including experience, knowledge of what a horse can do, knowledge of what a horse will do, what the trainer is trying to get the horse to do, what equipment is involved in the training, and the trainer's confidence in the equipment.

Control over the horse is typically provided through a combination of mechanical, physical restraints, and trained responses to commands from the human trainer. Trained responses to commands can take a relatively long time to develop, depending on the character of the horse and the skills of the trainer, among other things. When developed, they can serve as near-reflexive conditioned responses that increase the trainer's knowledge of what the horse will do, while simultaneously increasing the trainer's control over the horse. Conditioned responses are not a guarantee of safe interaction with the horse, however, as the horse's animal instinct can sometimes suppress and overcome the conditioned response, most particularly when the animal is frightened.

Mechanical restraints, therefore, provide a second means of control that limit the physical range of movement of the horse or provide physical stimuli to goad the horse into a particular action. In some cases chemical restraint can also be employed, such as, for example in order to perform dental work on the horse, the horse must be subdued, anesthetized, and still. Chemical restraint is an extreme example of mechanical restraint—typical mechanical restraint is less restrictive. Furthermore, it is generally understood that equine training should involve as little painful or overly restrictive restraint as possible. Accordingly, the safety and well being of the horse is a high priority in any equine training. Thus, mechanical training and control equipment is designed with an eye towards minimizing restrictions on the horse's range-of-movement that are consistent with human safety.

Typical equine training is designed to develop the horse's skills in a training environment, so that those skills can be employed in an operational environment. As a very simple example, before a horse will take a human rider, the horse must be acclimated to human interaction. For more advanced skills, such as those performed at shows and competitive riding events, specialized training equipment is sometimes required. Much like training wheels for a child's bicycle, specialized training equipment can help the trainer guide the horse incrementally through small steps towards a difficult skill or skill set.

One example of equipment that can be employed in both a training environment and an operational environment is the modem bit and bridle system. Generally, the bridle is a network of restraints that fit over the horse's head and face, providing a safe, convenient control mechanism and coupling point for various control devices, such as reins, leads, and the bit. Similar to the bridle, a halter can be employed to provide control in a manner similar to the bridle, without the emphasis on riding that influences the bridle's design. The modem bit is typically a metal bar that is placed in the horse's mouth and coupled to the bridle. Certain horse breeds begin their training with a bit-less bridle and progress to a bit and bridle control system.

In either a bit-less, bit and bridle, or halter control system, however, it is often convenient for the trainer or rider to tie a length of rope to the bridle/halter to provide a guide mechanism to lead the horse to a desired action. When riding, the reins serve this purpose and allow the rider to provide pressure to the bridle, and therefore the horse's head, which the horse learns to interpret as a particular command. The same control theory applies to the halter, wherein a “lead” rope is attached to the halter, allowing the trainer to guide the horse to move in a particular direction or to stop moving. The lead is also often used by a trainer to help maintain control of the horse while a rider is riding the horse. As used herein, “lead” includes both leads and reins. One skilled in the art will understand that similar factors affecting leads also affect reins.

As a training aid, the lead is subject to periodic, often powerful, stresses. For example, as the lead is attached to the horse's head (through the halter/bridle), should the horse move its head quickly or violently, the resultant sharp pull on the lead can cause significant stress on the free end of the lead. In many instances, the free end is tied to a post or other fixed point. Where the free end is tied to a post, for example, a sharp pull can cause the free end to break free of the post or, more commonly, can cause failure in one or more of the devices coupling the lead to the bridle. Where a trainer is holding the free end of the lead, a sharp pull can jerk the lead out of the trainer's hands. If the trainer does not let go of the lead, the stress of the sharp pull can also cause failure in one or more of the devices coupling the lead to the bridle.

One such device, for example, is a metal “snap” often used to attach a lead/reins to the bridle/halter. The snap typically consists of a quick-release clasp fixed to a metal loop. The lead rope is run through the metal loop and braided into itself, forming a fixed coupling to the snap. Thus, the lead, through the quick-release clasp, can be attached and detached from the bridle/halter with relative ease. The snap, however, cannot be easily detached from the lead rope, without complicated and time-consuming un-braiding or destructive cutting of the lead rope.

In typical operation, the snap is affixed to the bridle/halter, and the trainer uses the lead to guide the horse. Similarly, the snap is often affixed to the bridle/halter to attach reins, as one skilled in the art will understand. As described above, the free end of the lead is also often tied to a post or other suitable fixed point. In high stress situations, such as the sharp pull described above, it is the metal loop of the snap that typically fails, decoupling the lead from the clasp, and therefore the lead from the horse. In certain scenarios, such as where a horse is particularly excited or agitated, a lead failure can be extremely dangerous. Particularly where the rider is new or inexperienced, the lead is sometimes the trainer's only safety mechanism to control the horse when the rider cannot.

Moreover, in typical systems, when the metal loop fails, the lead/snap system is rendered worthless. Replacing the snap is inefficient as un-braiding and/or re-braiding the lead loop is more time-consuming and expensive to the end-user than simply purchasing another lead/snap system. Additionally, when the metal loop fails, the trainer is left with an otherwise serviceable length of rope that cannot be employed for its intended purpose, that is, as a horse lead.

A need exists, therefore, for an improved horse lead system and related method that overcomes at least some of the disadvantages associated with prior systems and methods.

All references cited herein are incorporated by reference to the maximum extent allowable by law. To the extent a reference may not be fully incorporated herein, it is incorporated by reference for background purposes and indicative of the knowledge of one of ordinary skill in the art.

### SUMMARY

The problems presented in prior systems and methods are solved by the systems and methods of the present invention. In accordance with one embodiment of the present invention, a horse lead is provided. The horse lead includes a length of lead material comprising a first end and a second end. The first end comprises a permanently braided or twisted segment forming a first loop. A connector is coupled to the first loop and a second loop is formed, interconnected with the first loop. A snap is provided, comprising a clasp and a third loop, and the third loop is coupled to the second loop.

Other objects, features, and advantages of the present invention will become apparent with reference to the drawings and detailed description that follow.

### BRIEF DESCRIPTION OF THE DRAWINGS

FIG. 1 is a block diagram of a horse lead system in accordance with one embodiment of the present invention.

FIG. 2 is a block diagram of a horse lead system in accordance with another embodiment of the present invention.

FIG. 3 is a flow diagram of a horse lead method in accordance with one embodiment of the present invention.

### DETAILED DESCRIPTION

All references cited herein are incorporated by reference to the maximum extent allowable by law. To the extent a reference may not be fully incorporated herein, it is incorporated by reference for background purposes and indicative of the knowledge of one of ordinary skill in the art.

In the following detailed description of the preferred embodiments, reference is made to the accompanying drawings, which form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

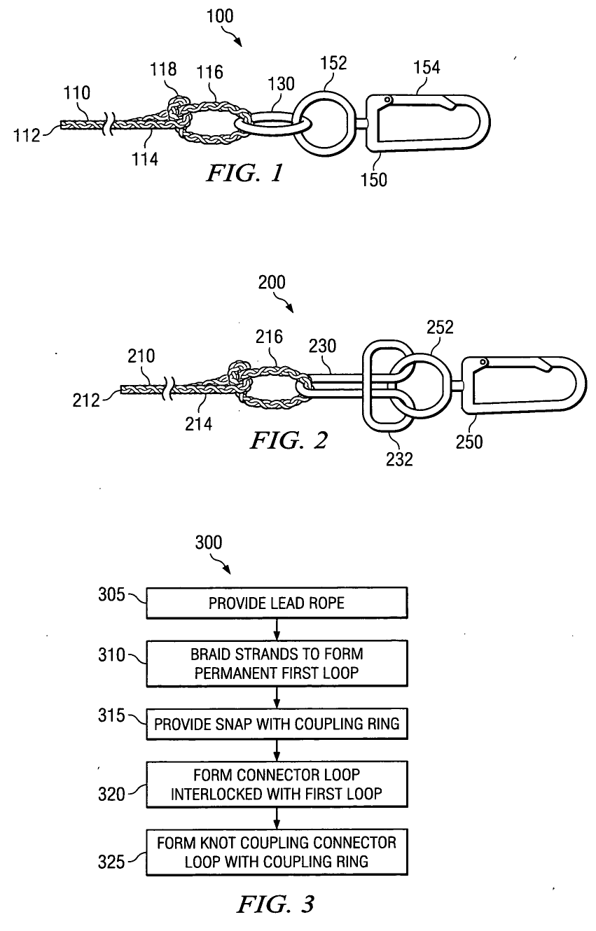

Referring now to FIG. 1, the reference numeral 100 generally designates a horse lead system in accordance with one embodiment of the present invention. Horse lead system 100 includes lead 110, connector 130, and snap 150. Generally, lead 110 is a braided rope and can be constructed out of cotton and/or nylon or other suitable material, as one skilled in the art will understand. For purposes of clarity, lead 110 is described below in the context of a rope horse lead. One skilled in the art will understand that lead 110 can also be reins. In an alternate embodiment, lead 110 is a leather strap. In an alternate embodiment, lead 110 is a woven material.

Lead 110 includes a free end 112 and a loop end 114. Generally, free end 112 can include any of a number of common devices or configurations applied to a bitter end of a rope, typically to help prevent fraying and/or un-braiding of the rope, as one skilled in the art will understand. Examples include a metal clamp, a metal grommet, a string tightly wrapped around the rope, heat-sealing or melting the rope end to fuse the strands together, and/or an end-knot tied at free end 112.

Generally, loop end 114 includes a loop 116. Loop 116 is formed by braiding the rope of lead 110 back onto itself, as one skilled in the art will understand. In an alternate embodiment, loop 116 is formed by twisting the rope of lead 110 back onto itself, as one skilled in the art will understand. In an embodiment where lead 110 comprises a leather strap, loop 116 can be formed by folding a length of leather back onto itself and securing the resultant loop in place with, for example, a metal grommet, as one skilled in the art will understand. Similarly, in an embodiment where lead 110 comprises woven material, loop 116 can be formed by folding a length of the woven material back onto itself and securing the resultant loop in place with, for example, a metal clamp, as one skilled in the art will understand.

In the illustrated embodiment, the individual strands are interwoven into the rope and secured with a string 118 tightly wrapped around the rope. One skilled in the art will understand that this process forms a permanent loop 116 at loop end 114. Accordingly, if it is desired that loop 116 interlock with another loop, the free loop end is passed through the target loop before being braided into the rope. Alternatively, the target loop can be formed to interlock with a completed loop 116, as described in additional detail below.

As illustrated, loop 116 is interlocked with connector 130. Connector 130 can be manufactured out of a number of materials, including cotton cloth, nylon fabric, canvas fabric, nylon rope, styrene or other polyester, tye wrap or twisties, cotton rope, plastic, and/or metal. In a preferred embodiment, connector 130 is a stitch-closed nylon or canvas loop. As used herein, “stitch-closed” means a connection formed between two ends of a continuous length of fabric, or two points on a continuous length of fabric, by stitching together the two ends, typically to form a single loop. Generally, the stitching employed to stitch-close a loop is configured to form a strong tie between the two ends. In one embodiment, stitch-closing can include inserting a small section of firm paper or thin plastic to strengthen the resultant seal. One skilled in the art will understand that other configurations can also be employed.

Generally, connector 130 is configured to form a stable, durable loop, suitable to interlock with loop 116 of lead 110 and a coupling loop of a metal snap. Accordingly, in the embodiment where connector 130 is a stitch-closed nylon loop, connector 130 can be formed before or after loop 116 is formed. For example, loop 116 can be formed first, after which one end of a length of nylon is fed through loop 116 and stitch-closed to the other end of the length of nylon to form a loop interlocked with loop 116. Alternatively, connector 130 can be formed as a stitch-closed nylon loop first, and the loop end of lead 110 can be fed through connector 130 and braided back onto itself to form loop 116. One skilled in the art will understand that other configurations can also be employed. Embodiments wherein connector 130 is a plastic or metal component are described in more detail below.

Connector 130 couples to snap 150. In particular, snap 150 includes a coupling ring 152 and a clasp 154. Clasp 154 is an otherwise conventional clasp or clip and can be a quick-release clasp or other suitable clasps well known to those skilled in the art. Coupling ring 152 is coupled to clasp 154. In a preferred embodiment, coupling ring 152 is coupled to clasp 154 so as to allow radial freedom of movement around the axis of the coupling point. Coupling ring 152 is a metal ring and is preferably manufactured out of the same material as clasp 154. In one embodiment, snap 150 is an otherwise conventional lead snap, as one skilled in the art will understand.

In the illustrated embodiment, snap 150 is an otherwise conventional lead snap. Accordingly, one skilled in the art will understand that coupling ring 152 is typically fabricated as a stable closed loop. That is, where clasp 154 is designed to permit opening and closing the loop formed by the clasp prongs, coupling ring 152 is configured as a permanently closed loop. Accordingly, in one embodiment, connector 130 is formed by threading one end of a length of fabric through loop 116 and coupling ring 152, and stitch-closing the threaded end to the free end of the fabric, thus forming a loop that interlocks with both loop 116 and coupling ring 152.

As described above, connector 130 can also be manufactured from plastic and/or metal. One skilled in the art will understand that metal and/or plastic loops generally form permanently closed loops. Accordingly, connector 130 can be formed contemporaneously with coupling ring 152, with loop 116 formed after, and interlocking with, connector 130.

As one skilled in the art will understand, the breaking strength of connector 130 can vary based on the material from which it is manufactured. In the context of horse training, breaking strength includes three types of failure resistance. First, connector 130 has a breaking strength in response to a sharp pull on the lead from either the horse or the human, sometimes referred to as “peak strength.” Second, connector 130 has a breaking strength in response to sustained tension on the lead, sometimes referred to as “maximum sustained strength.” Third, connector 130 has a breaking strength in response to a twist between snap 150 and lead 110, sometimes referred to as “torsional strength.” One skilled in the art will understand that there are other forces that wear on the mechanical integrity of connector 130, such as friction and weather. Such forces tend to operate over a longer time period, however, and are unnecessary to account for to understand the present invention.

Generally, there are two factors that determine the preferred material for connector 130 in a given instance. First, the breaking strength can be specifically selected based on the intended uses for lead system 100. For example, in a lead system 100 designed for use in training unbroken horses; connector 130 can be designed with a higher relative breaking strength, in order to ensure better control over the horse during the more unpredictable phases of the training and for safety. Similarly, connector 130 can be designed with a lower relative breaking strength, for use with otherwise fairly predictable horses, in order to reduce cost and for safety. The lower relative breaking strength can also serve as a warning device, indicating that the horse is agitated beyond its normal range. Accordingly, one skilled in the art will understand that connector 130 can be designed to break easier or harder depending on the animal involved in the training and the intended use for lead system 100.

Second, the design of connector 130 allows for more or less ease of attachment to loop 116 and coupling ring 152, by the end user of lead system 100. Where connector 130 is more easily formed to interlock with loop 116, the material used to construct connector 130 can have a breaking strength lower than that of loop 116. That is, where it is simple for the end user to form connector 130 through loop 116, connector 130 is designed to fail before loop 116. For example, where connector 130 is a carabineer clip, which is relatively easy to couple to loop 116, connector 130 can be formed from metal or plastic with a peak breaking strength lower than a peak breaking strength of loop 116. Similarly, in such a configuration, the breaking strength of connector 130 can be selected to be lower than the breaking strength of coupling ring 152. Thus, where connector 130 can be more easily formed to interlock with loop 116, connector 130 can be designed to fail before loop 116 and coupling ring 152.

Where connector 130 is less easily formed to interlock with loop 116, the material used to construct connector 130 can have a breaking strength higher than that of coupling ring 152. That is, where it is difficult for the end user to form connector 130 through loop 116, coupling ring 152 is designed to fail before connector 130 or loop 116. For example, where connector 130 is a stitch-closed fabric loop, which is relatively difficult for the end user to form through loop 116, connector 130 can be formed from canvas, nylon, leather, synthetic nylon, woven material, or other fabric in a configuration with a peak breaking strength higher than a peak breaking strength of coupling ring 152. Thus, where connector 130 can be more easily formed to interlock with loop 116, connector 130 can be designed to fail before loop 116 and coupling ring 152.

One skilled in the art will appreciate that where it is difficult for the end user to form connector 130 through loop 116, it is probable that it is also difficult for the end user to form connector 130 through coupling ring 152. Therefore, a preferred embodiment of lead system 100 is described below with respect to FIG. 2.

Referring now to FIG. 2, the reference numeral 200 generally designates a horse lead system in accordance with one embodiment of the present invention. Horse lead system 200 includes lead 210, connector 230, and snap 250. In the illustrated embodiment, lead 210 is a braided rope and can be constructed out of cotton and/or nylon or other suitable material, as one skilled in the art will understand.

Lead 210 includes a free end 212 and a loop end 214. Generally, free end 212 and loop end 214 are substantially similar to free end 112 and loop end 114 of FIG. 1 as described above. Thus, loop end 214 includes a loop 216, which is substantially similar to loop 116 of FIG. 1 as described above. Snap 250 includes coupling ring 252, which is substantially similar to coupling ring 152 of FIG. 1 as described above.

In the illustrated embodiment, connector 230 is a stitch-closed fabric loop. As shown, connector 230 is formed as a loop interlocking with loop 216 and coupled to coupling ring 252 through a knot 232. In the illustrated embodiment, knot 232 is a closed-loop slip knot. One skilled in the art will understand that other suitable knots can also be employed.

In particular, in the illustrated embodiment knot 232 is formed as follows. First, connector 230 is flattened and passed through coupling ring 252. Next, the loop formed by connector 230 is opened and coupling ring 252 is passed through connector 230. Tension is applied and the result is knot 232.

Thus, connector 230 forms a permanent loop interlocking with loop 216, and connector 230 is coupled to snap 250 through coupling ring 252 in a manner that allows for relatively simple decoupling. Accordingly, one skilled in the art will appreciate why the breaking strength of connector 230 in the illustrated embodiment is selected to be higher than the breaking strength of coupling ring 252. If coupling ring 252 fails, or decouples from snap 250, the failed snap 250 can be easily removed and a replacement snap 250 can be attached to connector 230 through knot 232. Moreover, one skilled in the art will understand that given the ease with which snap 250 can be replaced, lead system 200 can be readily customized with a variety of types and configurations of snap 250.

Additionally, in an alternate embodiment, connector 230 can be coupled to loop 216 through a second knot 232 (not shown). So configured, if loop 216 fails, connector 230 can be readily decoupled from loop 216 and coupled to a replacement loop 216. One skilled in the art will understand that other configurations can also be employed.

Referring now to FIG. 3, the reference numeral 300 generally indicates a flow diagram illustrating a method in accordance with one embodiment of the present invention. Generally, the steps of the method can be employed to generate a horse lead system such as, for example, lead system 100 of FIG. 1 and/or lead system 200 of FIG. 2.

The process begins at step 305 wherein a rope is provided. The rope can be, for example, lead 110 of FIG. 1. At next step 310, the strands of an end of the rope provided in step 305 are braided to form a permanent first loop. This step can include, for example, forming loop 116 of FIG. 1, and strengthening loop 116 with string 118.

At next step 315, a snap with a coupling ring is provided. The snap can be, for example, snap 150 of FIG. 1. At next step 320, a connector loop is formed, which interlocks with the first loop formed in step 310. The connector loop can be, for example, connector 130 of FIG. 1 or connector 230 of FIG. 2.

At next step 325, a knot is formed to couple the connector formed in step 320 with the coupling ring of the snap provided in step 315, and the process ends. In one embodiment, the knot can be, for example, knot 232 of FIG. 2.

In an alternate embodiment, in the event of a snap failure, the knot formed in step 325 can be undone, a replacement snap provided, and a new knot formed to couple the connector loop formed in step 320 with the newly provided snap. One skilled in the art will understand that other configurations can also be employed.

As described above, a primary advantage of the present invention is to provide a horse lead system that overcomes some of the disadvantages of prior systems and methods. In particular, one advantage includes providing a horse lead system that allows for simplified replacement of failed snaps, particularly failed coupling rings. Another advantage is providing a horse lead system and method that allows for simplified exchange of snaps, without requiring un-braiding and re-braiding of the permanent loop of the lead rope.

Still another advantage is providing a horse lead system that allows for customization of connector loops based on the breaking strength of one or more components of the horse lead system. Yet another advantage is providing a horse lead system that allows for customization based on the intended use of the horse lead system. Still another advantage is providing a horse lead system that reduces lead replacement cost and increases efficient re-use of valuable equipment.

Even though many of the examples discussed herein are applications of the present invention in the context of equine training and control equipment, particularly horse leads, the present invention also can be applied to other types of detachable guide or control ropes, including but not limited to ropes and lines used onboard ships and other vessels, ropes and lines used in spelunking and/or mountaineering, ropes and lines used as safety or life-lines, and other suitable systems. Thus, one skilled in the art will see that the present invention can be applied in many areas where there is a need to provide a guide or control lead with a detachable, failure-prone, end link component.

It should be apparent from the foregoing that an invention having significant advantages has been provided. While the invention is shown in only a few of its forms, it is not just limited but is susceptible to various changes and modifications without departing from the spirit thereof.

I claim:

1. A horse lead, comprising:
a length of lead material comprising a first end and a second end, wherein the first end comprises a permanently braided segment forming a first loop;
a connector coupled to the first loop and forming a second loop interconnected with the first loop; and
a snap comprising a clasp and a third loop, the third loop coupled to the second loop.

2. The lead according to claim 1 wherein the connector is a stitch-closed nylon loop.

3. The lead according to claim 1 wherein the connector is s stitch-closed synthetic nylon loop.

4. The lead according to claim 1 wherein the connector is a stitch-closed canvas loop.

5. The lead according to claim 1 wherein the connector is a stitch-closed loop of woven material.

6. The lead according to claim 1 wherein the connector is a braided rope loop.

7. The lead according to claim 1 wherein the connector is an annular metal clip.

8. The lead according to claim 1 wherein the connector is a stitch-closed canvas loop and the second loop comprises a folded-loop knot.

9. The lead according to claim 1 wherein a breaking strength of the second loop is greater than a breaking strength of the third loop.

10. The lead according to claim 9 wherein a breaking strength of the second loop is greater than a breaking strength of the first loop.

11. The lead according to claim 1 wherein a breaking strength of the second loop is less than a breaking strength of the first loop.

12. The lead according to claim 1 wherein a breaking strength of the second loop is greater than a breaking strength of the first loop.

13. The lead according to claim 1 wherein the snap is configured to couple to a horse bridle.

14. The lead according to claim 1 wherein the connector forms a permanent second loop.

15. The lead according to claim 1 wherein the lead comprises reins.

16. The lead according to claim 1 wherein the permanently braided segment comprises a twisted segment.

17. The lead according to claim 1 wherein the length of lead material comprises a leather strap.

18. The lead according to claim 1 wherein the length of lead material comprises rope.

19. The lead according to claim 1 wherein the length of lead material comprises woven material.

20. A method, comprising:
providing a length of lead material comprising a first end and a second end;
braiding the first end of the length of lead material through a point between the first end and the second end to form a permanent first loop;
providing a metal snap comprising a clasp and a second loop;
forming a third loop with a connector, wherein the first loop is interlocking with the third loop, and the third loop is coupled to the second loop.

21. The method according to claim 20 wherein the connector is a stitch-closed nylon loop.

22. The method according to claim 20 wherein the connector is a stitch-closed canvas loop.

23. The method according to claim 20 wherein the connector is a braided rope loop.

24. The method according to claim 20 wherein the connector is an annular metal clip.

25. The method according to claim 20 wherein the third loop is formed through a folded-loop knot.

26. The method according to claim 20 wherein a breaking strength of the third loop is greater than a breaking strength of the second loop.

27. The method according to claim 26 wherein a breaking strength of the third loop is greater than a breaking strength of the first loop.

28. The method according to claim 20 wherein a breaking strength of the third loop is less than a breaking strength of the first loop.

29. The method according to claim 20 wherein a breaking strength of the third loop is greater than a breaking strength of the first loop.

30. The method according to claim 20 wherein the clasp of the metal snap is configured to couple to a horse bridle.

31. The method according to claim 20 further comprising forming a fourth loop at the second end of the length of rope.

32. The method according to claim 20 wherein braiding comprises twisting.

33. The method according to claim 20 wherein the length of lead material comprises a lead.

34. The method according to claim 20 wherein the length of lead material comprises reins.
